(19) United States
(12) Patent Application Publication
(10) Pub. No.: US 2008/0183371 A1
(43) Pub. Date: Jul. 31, 2008

(54) DEVICE AND METHOD FOR A VEHICLE

(75) Inventors: Werner WOLFGANG, Ravensburg (DE); Olrik WEINMANN, Eriskirch (DE); Peter REITZ, Neukirch (DE); Uwe GRIESMEIER, Markdorf (DE); Maik WURTHNER, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/018,411

(22) Filed: Jan. 23, 2008

(30) Foreign Application Priority Data
Jan. 30, 2007 (DE) 10 2007 004 412.9

(51) Int. Cl. F02D 41/00

(52) U.S. Cl. 701/103

(57) ABSTRACT

A device for a motor vehicle having an internal combustion engine which drives a transmission, via an automated clutch. The transmission has one or more continuous or stepped variable ratios and the vehicle has a coasting cutoff signal. While coasting, the coasting cutoff signal can interrupt the supply of fuel to the internal combustion engine and, upon reaching or falling below a previously defined rotational speed, causes the supply of fuel to the internal combustion engine is resumed. The transmission has, In addition to the gear ratios needed for driving, coasting ratios for operating the transmission with a coasting cutoff signal, which enables lower reduction ratios than the ratios for the driving operation in order to reduce the drag torque of the internal combustion engine that acts on the output. The additional ratios are either stepped or continuously variable.

This application claims priority from German Application Serial No. 10 2007 004 412.9 filed Jan. 30, 2007.

### FIELD OF THE INVENTION

The invention concerns a device and method for optimizing the coasting operation of a vehicle.

### BACKGROUND OF THE INVENTION

Vehicles are equipped with known coasting cutoff signals for the purpose of reducing fuel consumption. They operate in a manner such that, for example, when the driver removes gas while the internal combustion engine is working, the fuel supply is cutoff and the internal combustion engine is driven by the actual kinetic energy of the vehicle. The fuel supply remains cutoff until the driver again demands power from the internal combustion engine, the rotational speed of the internal combustion engine reaches a previously defined restored rotational speed or another demand generates a change of the driving conditions. During the coasting operation, especially when fuel is cutoff, fuel is conserved wherefore it is desirable to use the coasting cutoff as long as possible.

In DE 10 2004 052 786, it has been proposed to lower the restored rotational speed for opening the fuel supply in direction to the idling rotational speed during coasting cutoff, especially adjusting the idling rotational speed. An additional electric engine is used here, since the internal combustion engine needs a certain amount of time, when the rotational speed drops for opening the throttle valve and for building up a torque reserve so as to build up a strong enough torque and to support the drop of rotational speed prior to reaching the idling rotational speed. For the reasons given above, the restored rotational speed can be further arbitrarily lowered. It is typically at least 300 to 400 revs/min above the idling rotational speed.

The problem to be solved by the invention is to optimize the coasting operation of a vehicle which results in fuel economy.

### DETAILED DESCRIPTION OF THE INVENTION

During a coasting operation, if the lowest possible ratio or the highest possible gear of the transmission is selected, then the drag torque of the internal combustion engine acting on the output becomes reduced. If the lowest possible ratio or the highest possible gear have already been selected, then no further improvement of the coasting operation can result by reduction of the drag torque of the internal combustion engine acting on the output.

Accordingly, the invention concerns a device and a method for controlling a device for a motor vehicle having an internal combustion engine which, by way of an automated clutch, is in operative connection with a transmission. The transmission has one or more stepped or continuously variable ratios. A coasting cutoff signal of the internal combustion engine is available and is activated when the vehicle is coasting by stopping the supply of fuel to the internal combustion engine. When reaching or falling below a previously defined restored rotational speed of the internal combustion engine, the supply of fuel is resumed. Control of the coasting cutoff signal is effected by at least one electronic control unit, which exists in the vehicle, and receives, processes and supplies signals the same as data of the vehicle The control can be furnished either to one or more control units.

To reduce the drag torque of the internal combustion engine, thereby making it practicable extend the route possible, the vehicle travels with coasting cutoff; additional ratios are available, which have lower reduction ratios than the ratios of the transmission provided for operation of the vehicle. The additional ratios are either stepped or continuously variable and are dimensioned only for the coasting operation of the internal combustion engine, which results in advantages in cost and weight. Devices suitable for the additional ratios are, for example gear wheel ratios or already known kinds of variators, such as belt, chain or toroidal variators, for continuously variable reduction of the ratio.

In an advantageous embodiment of the device, there is a device in the vehicle for the additional ratios in combination with the transmission and one additional brake. The additional ratios are provided in the drive train in a power flow direction before or behind the transmission, assembled with the transmission or the additional brake, or integrated in the transmission or the additional brake.

To control the device of the coasting operation and of the additional brake, the vehicle is provided as control lever with a pre-selection element, which is connected with the electronic control unit by data lines. The control lever starts from a zero position and from there can be directed in two directions: a first direction for increasing the braking resistance of the additional brake and a second direction for reducing the ratio of the transmission or the additional ratios.

The steps advantageously expand the pre-selection element, known for controlling of the additional brake, by one other possibility of selection, namely, the combined control of the additional brake with the coasting operation, which enables the driver to increase the drag torque of the vehicle or the drive train with the additional brake or to reduce it by utilizing the additional ratios.

Furthermore, it is advantageous that the pre-selection element is constructed to automatically move back to the zero position at least from its position for reducing the drag torque of the vehicle that acts on the output. It is also proposed that the pre-selection element of the additional brake and for the additional ratios are designed as control lever in the manner of a tilting lever, rotary lever or traction/pressure lever.

In vehicles having a cruise control or an adaptive cruise control, the driving speed data of the cruise control or the adaptive cruise control are available, via one line, to the electronic control unit and used for control of the optimized coasting operation.

Moreover, an optimized coasting operation of the vehicle is terminated depending on other operating and/or driving conditions of the motor vehicle, for example, by temperature changes of the prime mover and/or action of a driver on the driving conditions.

In the coasting operation, when the vehicle is operated at low speeds and the internal combustion engine reaches the previously defined restored rotational speed, the fuel supply is reconnected and the internal combustion engine ignites which, due to the low rational speed of the internal combustion engine, results in stalling the internal combustion engine. In order to prevent this, it is possible to retain the coasting operation of the vehicle by automatically, or by means of the driver, switching to a gear or a ratio which makes it possible to increase the rotational speed of the internal combustion engine. This prevents the internal combustion engine from stalling. A stronger drag torque of the internal combustion engine that acts on the output is thereby produced such that it is not possible to drive for long at low speeds in coasting operation.

In order to make the phase of the coasting cutoff signal longer, even at low speeds, the restored rotational speed of the coasting cutoff signal is defined as a rotational speed below the idling rotational speed, but above a lower rotational speed threshold to ensure a sufficient drive to power one or more auxiliary units such as a steering auxiliary pump.

It is finally proposed that when the fuel supply is restored at a rotational speed below the idling rotational speed, a clutch is disengaged in the drive train of the vehicle to properly start the internal combustion engine and to further ensure a comfortable drive of the vehicle.

1-10. (canceled)

11. A device for a motor vehicle having an internal combustion engine operatively connected with a transmission via an automated clutch, the transmission having at least one of continuously variable ratios and stepped variable ratios and the internal combustion engine generating a possible coasting cutoff signal which, during a coasting operation of the vehicle, produces an interruption of a supply of fuel to the internal combustion engine and upon one of reaching and falling below a previously defined restored rotational speed of the internal combustion engine, effects a restoration of the supply of fuel to the internal combustion engine, and at least one electronic control unit being available in the vehicle for receiving, processing and emitting signals based on data of the vehicle,
wherein, in addition to driving ratios provided in the transmission for driving of the vehicle, coasting ratios are provided for a coasting operation with coasting cutoff signal, the coasting ratios provide lower reduction ratios than the driving ratios for the driving operation, which reduce a drag torque of the internal combustion engine acting on an output, and the coasting ratios are one of stepped variable ratios and continuously variable ratios.

12. The device for a motor vehicle according to claim 11, wherein an additional brake and a device, for producing the coasting ratios, is one of integrated in the transmission, located, in a direction of power flow, before the transmission and behind the transmission and integrated with the additional brake.

13. The device for a motor vehicle according to claim 12, wherein a pre-selection element, for the additional brake and the coasting ratios, is connected with the electronic control unit such that the pre-selection element is adjustable, from a first position, to one of a second position for increasing a braking resistance of the additional brake and a third position for one of reducing the driving ratio of the transmission and selecting the coasting ratio.

14. The device for a motor vehicle according to claim 13, wherein the pre-selection element returns to the first position at least from a position at which drag torque of the vehicle acting upon the output is reduced.

15. The device for a motor vehicle according to claim 13, wherein the pre-selection element of the additional brake is one of a swivel lever, a rotary lever and a traction/pressure lever.

16. A method of controlling a device for a motor vehicle having an internal combustion engine operatively connected with a transmission via an automated clutch, the transmission having at least one of continuously variable ratios and stepped variable ratios and the internal combustion engine generating a possible coasting cutoff signal which, during a coasting operation of the vehicle, produces an interruption in a supply of fuel to the internal combustion engine and upon one of reaching and falling below a previously defined restored rotational speed of the internal combustion engine, effects a restoration of the supply of fuel to the internal combustion engine, at least one electronic control unit being available in the vehicle for receiving, processing and emitting signals based on data of the vehicle, and in addition to driving ratios provided in the transmission for driving of the vehicle, coasting ratios are provided for coasting operation with coasting cutoff signal, the coasting ratios make lower reduction ratios possible than the driving ratios for the driving operation, for reducing a drag torque of the internal combustion engine acting on an output, the coasting ratios are one of stepped variable ratios and continuously variable ratios, the method comprising the step of:
utilizing values for adjusting one of a cruise control and an adaptive cruise control to electronically control the coasting operation.

17. The method according to claim 16, further comprising the step of terminating the coasting operation of the vehicle depending on at least one of a temperature of the internal combustion engine and an action of a driver upon driving conditions.

18. The method according to claim 16, further comprising the step of defining the previously defined restored rotational speed of the internal combustion engine at a rotational speed below an idling rotational speed,

19. The method according to claim 16, further comprising the step of, at a rotational speed below an idling rotational speed, disengaging the automatic clutch, located between the internal combustion engine and the transmission, when the supply of fuel is reconnected to the internal combustion engine.

20. The method according to claim 16, further comprising the step of defining the previously defined restored rotational speed of the internal combustion engine as being higher than a lower rotational speed threshold, at which at least one auxiliary power units of the motor vehicle driven.

21. A method for controlling drive of a motor vehicle having an internal combustion engine coupled, via a clutch, to one of a continuously variable transmission and multi-gear transmission, the internal combustion engine communicating with a fuel supply which has a coasting fuel cutoff, the method comprising the steps of:
monitoring signals of the vehicle with an electronic control unit to determine when the vehicle is coasting;
directing the coasting fuel cutoff with the electronic control unit to disconnect the supply of fuel from the internal combustion engine when the electronic control unit determines that the vehicle is coasting;
reducing transmission ratios to lower than driving ratios when the coasting fuel cutoff is directed to disconnect the supply of fuel from the internal combustion engine for reducing drag torque of the internal combustion engine on an output of the vehicle; and
reconnecting the supply of fuel to the internal combustion engine when, as determined by the electronic control unit, a rotational speed of the internal combustion engine is one of essentially equal to and below a predefined rotational speed.
